(19) United States
(12) Patent Application Publication
(10) Pub. No.: US 2022/0404935 A1
(43) Pub. Date: Dec. 22, 2022

(54) DUAL PANEL MAPPING MODAL

(71) Applicant: ADP, LLC, Roseland, NJ (US)

(72) Inventors: Lauren Miller, Brooklyn, NY (US); Claire Casaregola, Brooklyn, NY (US); Michael Greene, Seattle, WA (US); Elizabeth Gao, Clinton, NJ (US); Yair Pike, San Francisco, CA (US); Harshita Daddala, New York, NY (US)

(21) Appl. No.: 17/350,165

(22) Filed: Jun. 17, 2021

(51) Int. Cl. G06F 3/0482; G06F 3/0484

(52) U.S. Cl. CPC G06F 3/0482; G06F 3/0484

(57) ABSTRACT

The present disclosure relates generally to a development tool and, more particularly, to a development tool comprising a dual panel mapping modal. The method includes displaying, by a computer system, a first display including data blocks of a data contract document and a second display including fields of an object model, in a single graphical user interface. The method further includes mapping, by the computer system, the data blocks in the first display to the fields of the object model in the second display by selection of the data blocks in the first display and selection of the fields in the second display.

### TECHNICAL FIELD

The present disclosure relates generally to a development tool and, more particularly, to a development tool comprising a dual panel mapping modal.

### BACKGROUND

The development of computer applications is a complex task that takes on many forms including, for example, building of data contract documents, data structures, fields, user interfaces, etc. In general, developers take their data structures and data fields and connect or map them to a block or field in the applications in which they are building. The data fields can be connected to snippets of code used for calculations, creating application logic or building out the user interface of their applications.

Currently, developers connect the data fields to their application fields one by one, which is a very cumbersome and time consuming process particularly when an error occurs in the mapping or linking of data structures to fields. By way of example, when an error does occur, a developer cannot tell where the error occurred and has to click on each and every field to determine where a problem exists. In this way, when a data structure is not properly mapped to a field, the developer needs to manually search for the appropriate field, which is provided in a different interface, compare the field to the data structure and then manually map the data structure to the field.

One specific example is connecting a data contract document (e.g., a tool that serves as a communication layer between a data source and the consumers of data) to user interface (UI) components on a tile document (e.g., a tool for building interfaces on the platform). If a developer made changes to either of the documents, an error would surface because the mapped lines would become invalid. When this error occurs, a developer cannot tell where the error was and has to select each and every field to determine where the problem exists, e.g., broken link in the mapping. Once the problem is found, the developer then needs to manually map the field to the document, which occurs in a different page. Accordingly, the developer is not provided with any simple means to easily compare data sets and fields and then make the appropriate mapping. In addition, the developer is not provided with any means to understand the full picture of their data in the documents and they are unable to tell where errors are coming from in order for them to be debugged.

### SUMMARY

In a first aspect of the present disclosure, a method comprises: displaying, by a computer system, a first display comprising data blocks of a data contract document and a second display comprising fields of an object model, in a single graphical user interface; and mapping, by the computer system, the data blocks in the first display to the fields of the object model in the second display by selection of the data blocks in the first display and selection of the fields in the second display.

In another aspect of the present disclosure, there is a computer program product for mapping data blocks of a data document to fields of an object model. The computer program product includes one or more computer readable storage media having program instructions collectively stored on the one or more computer readable storage media. The program instructions are executable to: display a list of one or more data contract documents; display data blocks of a data contract document selected from the list of the one or more data contract documents; display an object model comprising fields that are automatically generated from and associated with the data blocks of the selected data contract document; and map one or more of the data blocks to the fields of the object model; and save the data blocks that are mapped to the fields in a single save operation.

In a further aspect of the present disclosure, there is a computer system for mapping data blocks of a data document to fields of an object model. The system includes a processor, a computer readable memory, one or more computer readable storage media, and program instructions collectively stored on the one or more computer readable storage media. The program instructions are executable to: display, in a first display, data contract blocks of one or more data contract documents; display, in a second display, fields of an object model that are associated with the data contract blocks, the second display being in a same graphical user interface screen as the first display; assign no values to the data contact blocks that are not mapping to a corresponding field of the object model; update the object model to a set of fields which can be mapped to a selected data contract block; map at least one of the set of fields to the selected data contract block; and save, in a single operation, the mapped data contact blocks.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 is an illustrative architecture of a computing system implemented in embodiments of the present disclosure.

FIG. 2 shows a block diagram of a data contract document and object model in accordance with aspects of the present disclosure.

FIG. 3 shows a view of a data contract document and data contract tool box panel in accordance with aspects of the present disclosure.

FIG. 4 shows an expanded view of exemplary panels comprising a data contract document and an object model in accordance with aspects of the present disclosure.

FIG. 5 shows an expanded view of the exemplary panels of FIG. 4, in which a particular data contract block of a data contract document has been selected in accordance with aspects of the present disclosure.

FIG. 6 shows an expanded view of the exemplary panels of FIG. 4, in which a particular field of an object model has been selected in accordance with aspects of the present disclosure.

FIG. 7 shows an expanded view of the exemplary panels of FIG. 4, in which a static value has been added to a data contract block in accordance with aspects of the present disclosure.

FIG. 8 shows an expanded view of the exemplary panels of FIG. 4, in which an error is noted in a mapped path of a data contract block in accordance with aspects of the present disclosure.

FIG. 9 depicts an exemplary flow for a process in accordance with aspects of the present disclosure.

### DETAILED DESCRIPTION OF ASPECTS OF THE INVENTION

The present disclosure relates generally to a development tool and, more particularly, to a development tool comprising a dual panel mapping modal and method of use. More specifically, the development tool comprises a dual window (panel) interface having side-by-side panels which display, at least, a data contract document and an object model. In embodiments, the panel of the data contract document may include data contract blocks and the panel of the object model may include fields that correspond to the data contract blocks. Advantageously, this side-by-side panel configuration allows the user to easily compare and map blocks of the data contract document to respective fields in the object model. This eliminates the need to individually select a data contract block, search for an individual object field on a different page, map the field to the data contract block and save the mapping one at a time.

In more specific embodiments, the single graphical user interface comprising the dual panel modal provides a user, e.g., software or application developer, with a simplified visual overview of data contract blocks of a data contract document and fields of an object model in a side-by-side fashion. In embodiments, the object model may include values (fields) for any particular document that is opened, whether it be a tile document, logiflow (e.g., a tool for defining and executing server side logic that is used to interact with external services, read and write data, validate and process data, and send notifications to end users and other services) or a business rule (e.g., a tool for implementing rules and business logic to perform). In any of these scenarios, the dual panel mapping modal provides the user with the capability to easily compare, map (e.g., bind) and/or edit data contract blocks in the data contract document to fields in the object model in a single view, amongst other features, without the need for complex searches or viewing of other pages.

Accordingly, the dual panel mapping modal provides many advantages in a technology field for developing computer applications, compared to current systems/processes/methods. These technological advantages include, amongst others:

(i) the ability to easily compare data contract blocks to fields (values) in an object model in a single view;

(ii) the ability to map data contract blocks to fields in an object model without the need to view other pages or perform complex searches;

(iii) the ability to easily determine whether a data contract block has already been matched to a field in the object model;

(iv) the ability to enter (e.g., associate) static values or dynamic values for individual data contract blocks;

(v) the ability to map external data links to the data contract blocks;

(vi) the ability to save all mapped values of plural data contract blocks in a single process;

(vii) the ability to easily determine whether an error in mapping occurred between a data contract block and a field in the object model, in a single view; and

(viii) overall, saving considerable time when developing computer applications.

As should be understood by those of skill in the art, the data contract document allows a user to build a tile or other document for a computer application. The tile, for example, includes components such as buttons, calculations, labels, tables, data fields, etc., used to build a front end module or computer application, e.g., profile page of a company. The data contract document defines the information of data fields in the front end module or computer application and links the data fields to one or more databases. For example, the data contract may be an agreement that describes the type of data to be exchanged between the database and the front end application. The object model, on the other hand, is built separately inside the tile and is used to convert the information from the data contract document to ensure that retrieved data from the database can be displayed and the computer application properly functions. So, in this way, it is possible to map between the database and the data contract document and from the data contract document to the tile, itself.

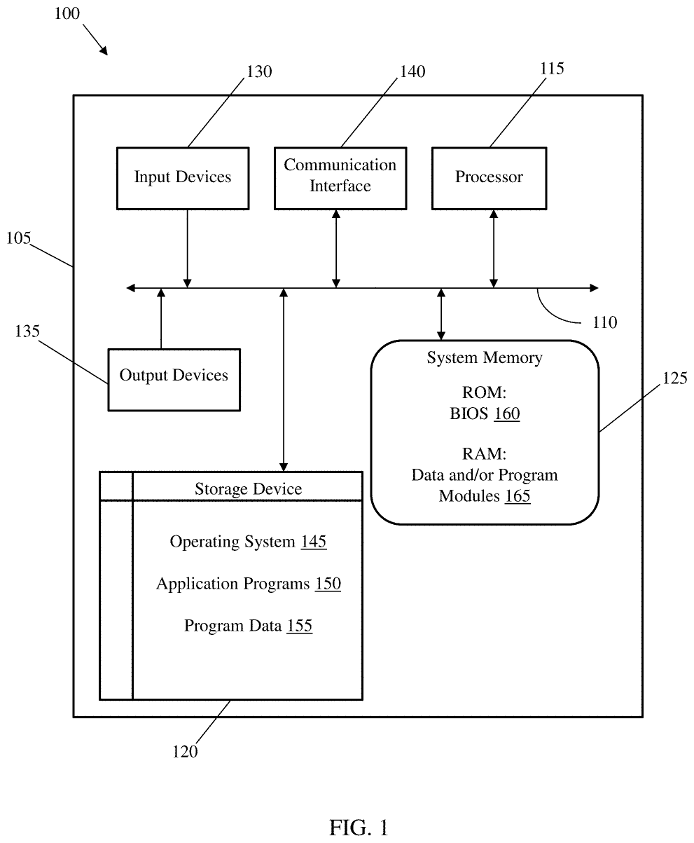

FIG. 1 is an illustrative architecture of a computing system 100 implemented in embodiments of the present disclosure. The computing system 100 is only one example of a suitable computing system and is not intended to suggest any limitation as to the scope of use or functionality of the disclosure. Also, computing system 100 should not be interpreted as having any dependency or requirement relating to any one or combination of components illustrated in computing system 100.

As shown in FIG. 1, computing system 100 includes a computing device 105. The computing device 105 can be resident on a network infrastructure such as within a cloud environment or may be a separate independent computing device (e.g., a computing device of a third party service provider). The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more processors or microprocessors that include any processing circuitry operative to interpret and execute computer readable program instructions, such as program instructions for controlling the operation and performance of one or more of the various other components of computing device 105. In embodiments, processor 115 interprets and executes the processes, steps, functions, and/or operations of the present disclosure, which may be operatively implemented by the computer readable program instructions. For example, processor 115 enables the computing device 105 to display side-by-side panels for the user to view and, in embodiments, match or bind fields between the data contract document and the object model fields.

In embodiments, processor 115 may receive input signals from one or more input devices 130 and/or drive output signals through one or more output devices 135. The input devices 130 may be, for example, a keyboard, touch sensitive user interface (UI), etc., as is known to those of skill in the art such that no further description is required for a complete understanding of the present disclosure. The output devices 135 can be, for example, any display device, printer, etc., as is known to those of skill in the art such that no further description is required for a complete understanding of the present disclosure.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present disclosure. In embodiments, storage device 120 may store operating system 145, application programs 150, and program data 155 in accordance with aspects of the present disclosure.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured to provide side-by-side panels which enable the user to view both data contract documents and object models, with the technological capability to map data block to a field in the object model. In addition, for example, computing system 100 may be configured to show an error in the mapping or linked data by highlighting any broken links, as well as fix these errors through a simple select and click operation. The computing system 100 may further be configured to save all of the mappings in a single save operation, saving considerable time and resources, amongst other features described herein. Accordingly, computing device 105 may perform tasks (e.g., process, steps, methods and/or functionality) in response to processor 115 executing program instructions contained in a computer readable medium, such as system memory 125.

The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 and/or the one or more output devices 135 to facilitate performance of the tasks and/or realize the end results of such tasks in accordance with aspects of the present disclosure. In additional or alternative embodiments, hardwired circuitry may be used in place of or in combination with the program instructions to implement the tasks, e.g., steps, methods and/or functionality, consistent with the different aspects of the present disclosure. Thus, the steps, methods and/or functionality disclosed herein can be implemented in any combination of hardware circuitry and software.

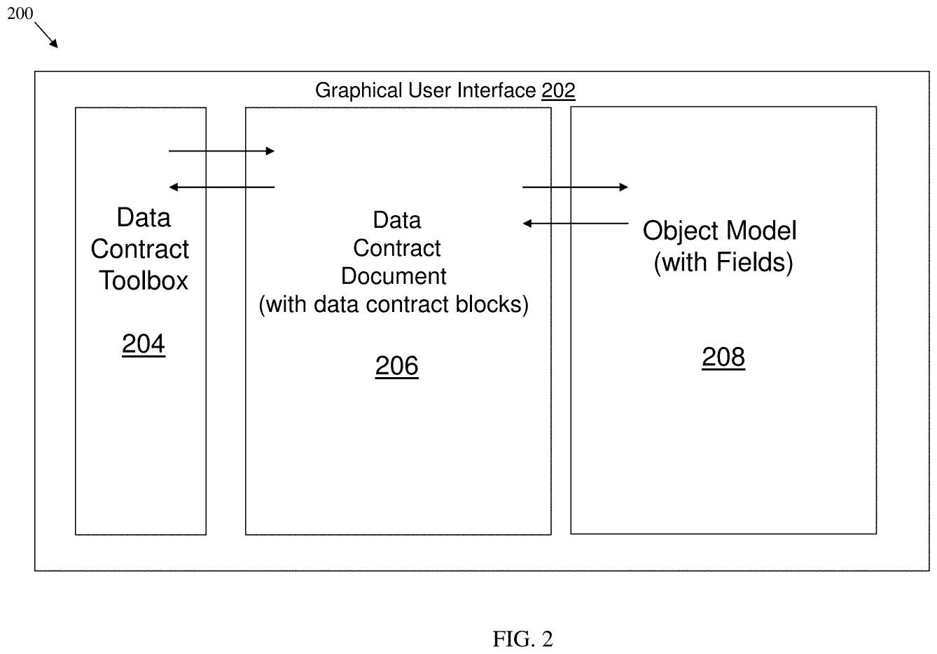

FIG. 2 shows a functional block diagram that illustrates the functionality in accordance with aspects of the present disclosure. In embodiments, the functional block diagram 200 includes a graphical user interface 202 (which may be equivalent to the output device 135 of FIG. 1). The graphical user interface 202 includes a data contract tool box panel 204 that stores a listing of all available data contract documents that may be inserted into tile or other document. In embodiments, the data contract documents can be created by the user or can be existing data contract documents provided by other users. In any scenario, the data contract documents can be interchangeable amongst different users and for different end use applications, e.g., for different application builds using tiles or other document types, depending on need and the particular information required for building a particular application.

Still referring to FIG. 2, the graphical user interface 202 includes side-by-side panels 206, 208. The panel 206 displays one or more data contract documents with data contract blocks, whereas, panel 208 displays an object model with fields (values) that correspond to the data contract blocks. In embodiments, panel 206 includes data contract documents that are selected from the data contract toolbox panel 204 and which are provided within a tile or other document type. And, as described in more detail herein, each of the data contract documents imported into panel 206 may include one or more data contract blocks which are used to define data fields in the tile or other document type as described above. The panel 208, on the other hand, includes a plurality of object fields that are generated from and matched to the specific data contract blocks in panel 206.

In embodiments, the object fields may be automatically generated and mapped to the specific data contract blocks. For example, the object fields may be automatically generated from the data contract blocks by simply selecting which data contract documents are to be imported into panel 206. That is, once a data contract document is added to the tile, all of those fields in the data contract document may automatically be added as fields in the object model in panel 208. In embodiments, the object fields can be automatically mapped to the data contract blocks by string matching processes known to those of skill in the art such that no further explanation is required for a complete understanding of the present disclosure. In alternative embodiments, the object fields can be automatically mapped to the data contract blocks by previous users of the data contact document. In this way, the side-by-side panels 206, 208 show in a single, integrated interface linked or mapped data, thus eliminating the needless amount of back and forth that this tedious work was previously required by the user.

In further embodiments, and as described in more detail herein, the side-by-side panels 206, 208 allow the user to easily compare object fields to data contract blocks and determine which fields are mapped to which data contract block. If there is no mapping or if there is an error in the mapping, the user can select the appropriate field and data contract block for such mapping using a click and save operation. Moreover, should the user want to make any changes to any of the mappings, the user can simply open the dual panel modal, e.g., side-by-side panels 206, 208, and make such changes including, for example, remapping or clearing any of the mappings by the same select and save process.

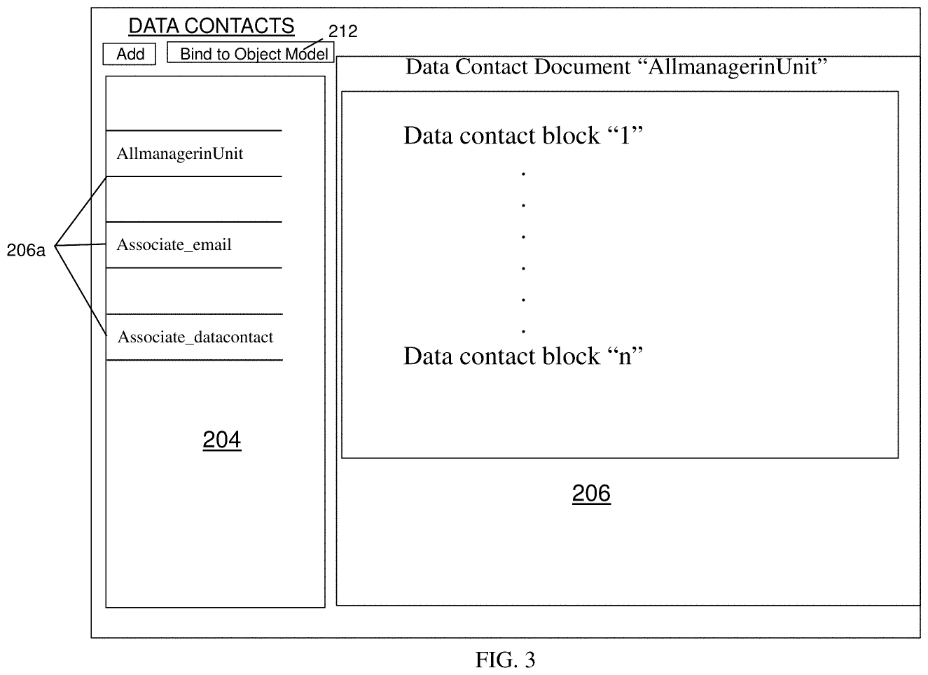

FIGS. 3-6 depict exemplary graphical user interfaces showing the mapping processes in accordance with aspects of the present disclosure. For example, FIG. 3 shows an expanded view of an exemplary panel 206 and data contract tool box panel 204. In use, the user can select any of the data contract documents 206a from the data contract tool box panel 204, at which time the selected data contract document will be imported and displayed in panel 206. In this illustrative example, the user selected data contract document “AllmanagerinUnit”. The panel 206 will display the selected data contract document and its specific data contract blocks, e.g., data block “1” to “n”. The user can bind (e.g., map) the specific data contract blocks to fields in an object model by selecting icon 212, e.g., “bind to object model”. This will be the entry point for mapping the selected data contract documents to the object model, with the object model acting as a bridge between the tile and the data contract document.

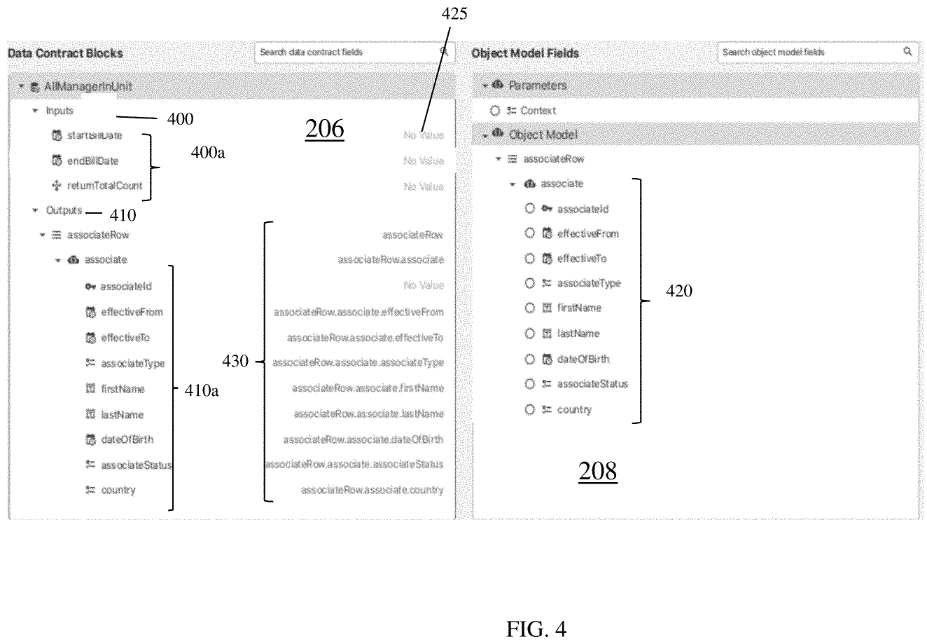

FIG. 4 shows an expanded view of exemplary panels 206, 208 in accordance with aspects of the present disclosure. As shown in FIG. 4, panel 206 includes specific inputs 400 and outputs 410 of a selected data contract document. The inputs 400 and outputs 410, for example, have different data contract blocks 400a and sub-blocks 410a, which correspond to fields 420 of the object model in panel 208. By way of illustrative non-limiting example, the different data blocks 400a may include items such as startBillDate, endBillDate, returnTotalcount which are also provided as fields in the object model; although other blocks and sub-blocks of the data contract document are contemplated herein.

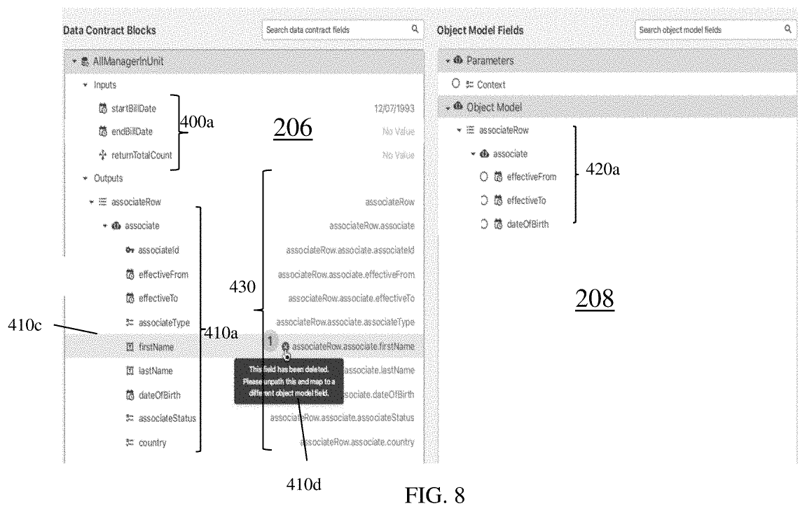

The data contract blocks 400a and sub-blocks 410a include descriptions 430 corresponding to a field 420, e.g., item or value, of the object model in panel 208. These corresponding descriptions depict a pathway of the mapping or binding to the related field 420 of the object model in panel 208. The value of the data contract blocks 400a and sub-blocks 410a may also be a “No Value” as shown by reference number 425, which indicates that there is no mapped item to the fields ion the object model. Further, as shown in FIG. 8, the data contract blocks 400a or sub-blocks 410a may be highlighted showing that an error occurred in the mapping due, for example, to the possibility that the user changed data in any of the documents.

As further shown in FIG. 4, the different data contract blocks 400a and sub-blocks 410a are presented in rows and should each correspond with a particular field (value) 420 of the object model shown in corresponding panel 208. This one-to-one correspondence between the data contract blocks 400a and sub-blocks 410a in panel 206 and fields 420 in panel 208 allows the user to easily compare which data contract blocks 400a and sub-blocks 410a are mapped or bound to the respective fields 420 in the object model in panel 208. In preferred embodiments, the fields 420 in panel 208 may be provided in a hierarchical format, e.g., tree format, with each mapped data contract block 400a and sub-block 410a having a corresponding pathway description 430 of the hierarchical format within panel 208. Similarly, the data contract blocks 400a and sub-blocks 410a can be in similar or corresponding hierarchical format, e.g., tree format, similar to that shown in panel 208.

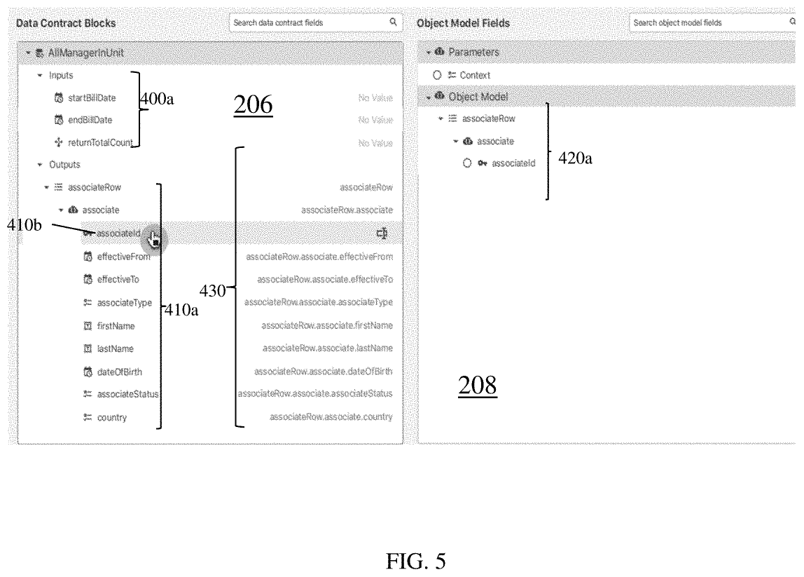

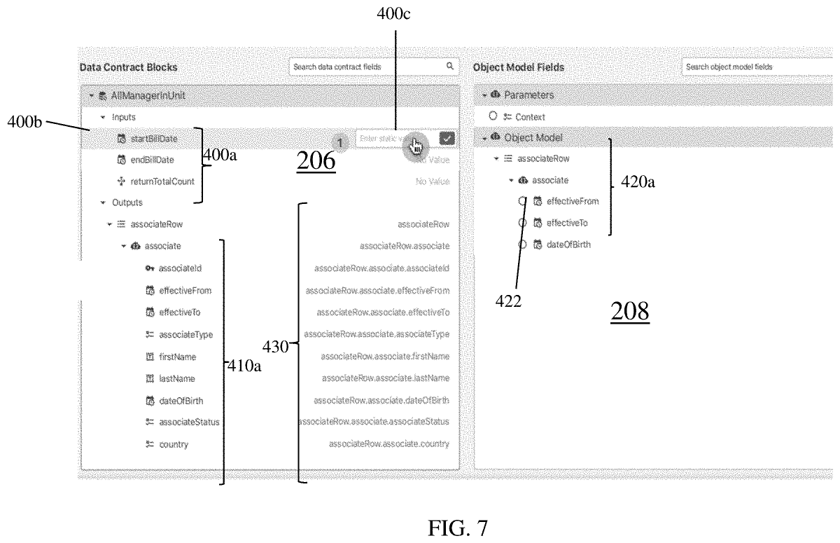

Still referring to FIG. 4, in some instances, the data contract blocks 400a and sub-blocks 410a may not be mapped to any of the fields 420 in the object model. In these instances, the user may manually map the data contract blocks 400a and sub-blocks 410a to a field 420 of the object model in panel 208 as shown in FIG. 5, for example, or enter a static value as shown in FIG. 7. Moreover, in embodiments, it is contemplated that each data contract block 400a and sub-block 410a may, by default, have “No Value” until the user maps that particular block to a value (field) in the object model. Also, by implementing the functionality herein, it is possible to remap any of the data contract blocks 400a or sub-blocks 410a to different fields 420 or to a static value or an external link.

FIG. 5 shows an expanded view of exemplary panels 206, 208 in which a particular data block 410b of a data contract document in panel 206 has been selected by the user. More specifically, in FIG. 5, the “associateId” block 410b, as an illustrative example, has been selected by the user. By selecting “associateId” block 410b, the row corresponding to “associateId” block 410b may become highlighted and the “No Value” indicator will be removed. In addition, after selecting the “associateId” block 410b from panel 206, the dual panel mapping modal can automatically update the object model 208 to includes only fields 420a which can be mapped to the selected data block. This is based on the input type, e.g., key, date/time, text, number, etc.

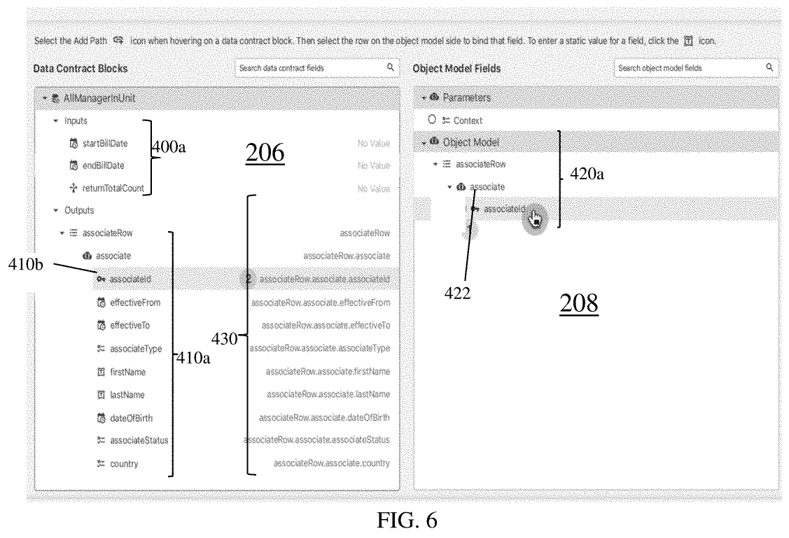

FIG. 6 shows an expanded view of exemplary panels 206, 208 in which a particular field 422 in panel 208 has been selected by the user. In embodiments, the field 422 in the object model will be a desirable match to bind or map with the “associateId” block 410a. By selecting the field 422, its row will become highlighted and the corresponding description 430 of the “associatedId” block 410a in panel 206 will be updated with the appropriate path that corresponds with the hierarchical format of field 422 in panel 208, e.g., associateRow.associat.associatedId.

This process can continue for additional data contract blocks 400a and sub-blocks 410a until all of the mappings are completed. Once all of the mappings are completed, the dual panel mapping modal will allow the user to save all of the mappings in a single, bulk save operation, at which time all of the pathway descriptions 430 may be updated. If there are any broken links, the data contract blocks 400a and sub-blocks 410a can be highlighted allowing the user to easily ascertain which blocks 400a, 410a are mapped to which fields in the object model and which links are broken (e.g., not properly mapped). Accordingly, the side-by-side panel configuration helps the user quickly scan which blocks are already mapped without having to select each block separately.

FIG. 7 shows an expanded view of exemplary panels 206, 208 in which a static value can be added to a data contract block by the user in panel 206. More specifically, in embodiments, the dual panel mapping modal will allow the user to add static values to any selected data contract blocks 400a and sub-blocks 410a by highlighting such data block, e.g., block 400b, at which time an input field 400c will be displayed in panel 206. A desired value, e.g., date or other value, can then be manually entered into the input field 400c. Depending on the data type, the static value can be a hard-coded string, Boolean value, remote schemas or a value from an array, amongst other values. Once the value is entered, it can be saved with all of the other mapped values. Note, though, that not every data contract block 400a and sub-block 410a requires a value.

FIG. 8 shows an expanded view of exemplary panels 206, 208 in which an error is noted in a mapped path of a data contract block within panel 206. In this illustrative representation, the dual panel mapping modal will include a highlighted sub-block 410c or an error icon which indicates that there is an error in the mapped path (e.g., a link is broken). In embodiments, the highlighting may be, e.g., different color text or other indication of an error. The error may be due to several factors such as the field was deleted in the data contract document or the user has dragged and dropped something in a tile, for example, that has not yet been mapped, in which case it needs to be re-mapped. In embodiments, a message 410d may also be displayed indicating that there is an error and that the particular block needs to be re mapped to a different field in the object model. As already noted herein, the path can be updated in the manner described with respect to FIGS. 3-7.

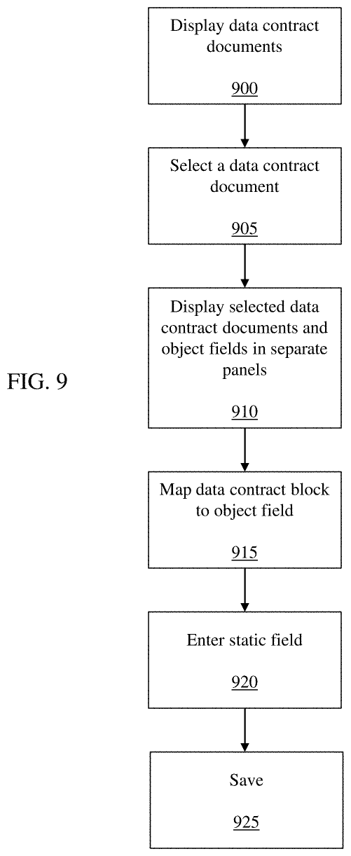

FIG. 9 depicts an exemplary flow for a process in accordance with aspects of the present disclosure. The exemplary flow can be illustrative of a system, a method, and/or a computer program product and related functionality implemented on the computing system of FIG. 1, in accordance with aspects of the present disclosure. The computer program product may include computer readable program instructions stored on computer readable storage medium (or media). The computer readable storage medium may include the one or more storage medium as described with regard to FIG. 1, e.g., non-transitory media, a tangible device, etc.

The method, and/or computer program product implementing the flow of FIG. 9 can be downloaded to respective computing/processing devices, e.g., computing system of FIG. 1 as already described herein, or implemented on a cloud infrastructure. Accordingly, the processes associated with each flow of the present disclosure can be implemented by special purpose hardware-based systems that perform the specified functions or acts or carry out combinations of special purpose hardware and computer instructions.

Also, in embodiments, the dual panel mapping modal can be implemented by a server or device which comprises modules, each of which may comprise one or more program modules such as program modules 165 described with respect to FIG. 1. The server or device may include separate modules (as represented by the blocks in FIG. 9) that perform each of the different steps as described above, or may be combined, integrated modules that perform the noted steps. Additionally, or alternatively, a single module may be implemented as multiple modules. In practice, the environment may include additional devices and/or networks; fewer devices and/or networks; different devices and/or networks; or differently arranged devices and/or networks than illustrated in FIG. 1.

Referring to FIG. 9, in step 900, the process will display one or more data contract documents in a single panel. In step 905, a user selects one or more data contract documents. In step 910, the process will display the selected data contract document in a first panel and its object fields will be displayed in a second panel, adjacent to the first panel. The object fields can be automatically generated by a matching process, for example. In step 915, a user can map a data contract block to an object field by selecting the data contract block and the respective object field in the adjacent panel. In this step, the process will highlight the selected row(s) associated with the data contract block. The process continues until all of the desired data blocks are mapped to the object fields. At optional step 920, the process will allow the user to add a static value into any of the data contract blocks. At step 925, the process will save all of the mapped data contract blocks in a single save operation, at which time the mapped descriptions, e.g., the pathway to the object field, will be displayed within the row of the respective data block.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A method of mapping data blocks of a data contract document with fields of an object model, comprising:
displaying, by a computer system, a first display comprising the data blocks of the data contract document and a second display comprising the fields of the object model, in a single graphical user interface; and
mapping, by the computer system, the data blocks in the first display to the fields of the object model in the second display by selection of the data blocks in the first display and selection of the fields in the second display.

2. The method of mapping of claim 1, wherein the first display and the second display are displayed in a side-by side panel configuration in the single graphical user interface.

3. The method of mapping of claim 1, wherein the fields of the object model are automatically generated upon selection of the data contract document.

4. The method of mapping of claim 1, wherein the fields of the object model are displayed in a hierarchal format in the second display.

5. The method of mapping of claim 4, wherein the data blocks are displayed in a hierarchal format in the first display.

6. The method of mapping of claim 5, wherein the hierarchal format of the data blocks correspond to the hierarchal format of the fields.

7. The method of mapping of claim 1, further comprising displaying in the first display a description of an object field pathway of the data blocks mapped to the fields in the second display.

8. The method of mapping of claim 1, further comprising saving the data blocks that are mapped to the fields in a single save operation.

9. The method of mapping of claim 1, further comprising updating the object model in the second display to include only fields which can be mapped to a selected data block in the first display.

10. The method of mapping of claim 1, further comprising highlighting any of the data blocks in the first display which are not properly mapped.

11. The method of mapping of claim 1, further comprising providing no value to one or more of the data blocks of the first display, which can be manually updated with a hard-coded string, a Boolean value, remote schemas or a value from an array.

12. A computer program product comprising one or more computer readable storage media having program instructions collectively stored on the one or more computer readable storage media, the program instructions executable to:
display a list of one or more data contract documents;
display data blocks of a data contract document selected from the list of the one or more data contract documents;
display an object model comprising fields that are automatically generated from and associated with the data blocks of the selected data contract document; and
map one or more of the data blocks to the fields of the object model; and
save the data blocks that are mapped to the fields in a single save operation.

13. The computer program product of claim 12, further comprising providing an indication in the display that a link to one or more of the data blocks of the data contract document is broken.

14. The computer program product of claim 12, wherein the mapping is a binding of the one or more of the data blocks to the fields of the object model.

15. The computer program product of claim 12, wherein the displayed data blocks of the selected data contract document is displayed in a side by side format with the object model.

16. The computer program product of claim 12, wherein the data blocks of the selected data contract document are initially assigned no value.

17. The computer program product of claim 12, further comprising updating the object model to include only fields which can be mapped to a selected data block of the selected data contract document.

18. The computer program product of claim 17, further comprising generating and displaying an object field pathway of the mapped selected data block with

19. A system comprising:
a processor, a computer readable memory, one or more computer readable storage media, and program instructions collectively stored on the one or more computer readable storage media, the program instructions executable to:
display, in a first display, data contract blocks of one or more data contract documents;
display, in a second display, fields of an object model that are associated with the data contract blocks, the second display being in a same graphical user interface screen as the first display;
assign no values to the data contact blocks that are not mapping to a corresponding field of the object model;
update the object model to a set of fields which can be mapped to a selected data contract block;
map at least one of the set of fields to the selected data contract block; and
save, in a single operation, the mapped data contact blocks.

20. The system of claim 19, further comprising generating a static field for entry of a static value to map to a data contract block that is assigned no value or is not mapped to the set of fields.
